(19) United States
(12) Patent Application Publication
(10) Pub. No.: US 2006/0259472 A1
(43) Pub. Date: Nov. 16, 2006

(54) Automated factory work analyzer

(76) Inventor: Mary MacClellan, Mill Creek, WA (US)

Correspondence Address: KLEIN, O'NEILL & SINGH, LLP, 43 CORPORATE PARK, SUITE 204, IRVINE, CA, 92606, US

(21) Appl. No.: 11/128,547

(22) Filed: May 13, 2005

(51) Int. Cl. G06F 17/30

(52) U.S. Cl. 707/3

(57) ABSTRACT

A method and system for analyzing work in a workplace is provided. The method includes providing a worker database; providing a task database for a plurality of tasks, which includes providing one or more task configurations for each of task and including configuration attributes for the task configurations; matching worker attributes with the task configuration attributes; evaluating the match of the worker attributes with the task configuration attributes; and updating the worker database and the task database upon satisfactory matching of worker attributes with the task configuration attributes. The system includes a worker database, wherein the worker database includes one or more worker attributes; a task database for a plurality of tasks; a user interface for accessing the worker database and the task database for entering worker and task information; and an evaluation module that evaluates a match of worker attributes with the task configuration.

### BACKGROUND OF THE INVENTION

1. Field of the Invention

This invention relates generally to work analysis in a workplace, and more particularly, to an automated computerized work analysis and matching process and system.

2. Description of Related Art

Complex workflow operations are common in today's workplace including modern factories. The operations involving human interaction and/or intervention may have a risk associated with it. Lack of proper tools, or the unsafe use of tools, posture(s) and worker positions during the performance of the tasks, and/or worker training may result in workplace injuries. Such worker injuries produce inefficient commercial results for businesses and cause pain to the individual workers.

Businesses allocate a significant amount of resources to identify causes and to prevent workplace injuries. Ergonomics, a study of relation between people and their work environment, is being employed at various stages in workplaces to minimize or eliminate workplace injuries and to boost worker productivity.

Conventional approach to ergonomics has been reactive rather than proactive. This means that the problem is addressed only after an injury has been reported rather than looking to analyze and minimize occurrences of such injuries. Conventional techniques employ manual systems for addressing workplace injuries that are local; and address only issues specific to an entity within the company rather than providing a centralized comprehensive approach. Others that have adopted technical solutions such as workplace reconfigurations, the solutions presented are very limited and seem to address same kinds of risk factors and recommend solutions that are not optimal.

Thus, there is a need to provide a work environment that has lower safety and ergonomic risks for both the individual worker and the greatest number of workers within the system.

Therefore, there is a need for a method and system that can automate how work tasks are performed in a commercial setting based on task requirements and the best worker match.

### SUMMARY OF THE INVENTION

In one aspect of the present invention, a method for analyzing work in a workplace is provided. The method includes providing a worker database, the worker database includes a plurality of worker attributes; providing a task database for a plurality of tasks, which includes providing one or more task configurations for each of task and includes configuration attributes for the task configurations; matching the worker attributes with the task configuration attributes; evaluating the match of the worker attributes with the task configuration attributes; and updating the worker database and the task database upon satisfactory matching of worker attributes with the task configuration attributes.

In yet another aspect of the present invention, a system for analyzing work in a workplace is provided. The system includes, a worker database, wherein the worker database includes one or more worker attributes; a task database for a plurality of tasks, wherein the task database includes one or more task configurations for the tasks with attributes for one or more task configurations; a user interface for accessing the worker database and the task database for entering worker and task information; and an evaluation module that evaluates a match of worker attributes with the task configuration.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

FIG. 1A shows a block diagram of a computing system for executing process steps, according to one aspect of the present invention;

FIG. 1B shows the internal architecture of the computing system in FIG. 1A;

FIG. 2 is a block diagram showing an overview of a task layout, used according to one aspect of the present invention;

FIG. 3 shows a block diagram of the overall database architecture of a system, according to one aspect of the present invention;

FIG. 4 shows a process flow diagram for matching worker(s) and tasks, according to one aspect of the present invention;

FIG. 5 shows an example of various how various tasks may be performed and used according to one aspect of the present invention; and

FIGS. 6A-6T are screen shots of a computerized system for automating work analysis/allocation, according to one aspect of the present invention.

### DETAILED DESCRIPTION OF THE PREFERRED EMBODIMENTS

The following description is provided to enable any person skilled in the art to make and use the invention and sets forth the best modes contemplated by the inventor of carrying out invention. Various modifications, however, will remain readily apparent to those skilled in the art, since the generic principles of the present invention have been defined herein, specifically to provide for a method and system for analyzing workflow in a workplace.

To facilitate an understanding of the preferred embodiments of the invention, the general architecture and operation of a computing system will be described. The specific architecture and operation of the preferred embodiments will then be described with reference to the general architecture.

Computing System:

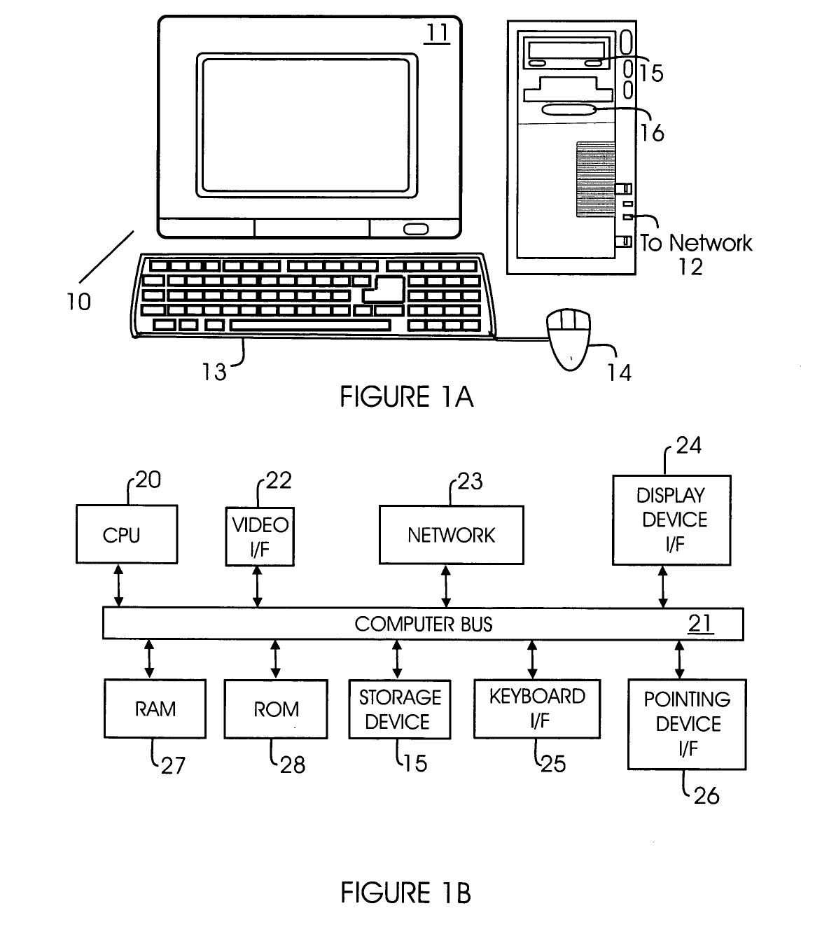

FIG. 1A is a block diagram of a computing system for executing computer executable process steps according to one aspect of the present invention. FIG. 1A includes a host computer 10 and a monitor 11. Monitor 11 may be a CRT type, a LCD type, or any other type of color or monochrome display.

Also provided with computer 10 are a keyboard 13 for entering data and user commands, and a pointing device (for example, a mouse) 14 for processing objects displayed on monitor 11.

Computer 10 includes a computer-readable memory storage device 15 for storing readable data. Besides other programs, storage device 15 can store application programs including web browsers by which computer 10 connect to the Internet (or any other network), and the computer-executable code according to the present invention.

According to one aspect of the present invention, computer 10 can also access computer-readable floppy disks storing data files, application program files, and computer executable process steps embodying the present invention or the like via a floppy disk drive 16. A CD-ROM, or CD R/W (read/write) interface (not shown) may also be provided with computer 10 to access application program files, and data files stored on a CD-ROM.

A modem, an integrated services digital network (ISDN) connection, or the like also provide computer 10 with a network connection 12 (may also be referred to as Network connection 12), for example a connection to the Internet that allows access to the World Wide Web (WWW) or to an intranet, a network of computers within a company or entity within a company. Network connection 12 allows computer 10 to download data files, application program files and computer-executable process steps embodying the present invention.

It is noteworthy that the present invention is not limited to the FIG. 1A architecture. For example, notebook or laptop computers, set-top boxes or any other system capable of running computer-executable process steps, as described below, may be used to implement the various aspects of the present invention.

FIG. 1B is a block diagram showing the internal functional architecture of computer 10. As shown in FIG. 1B, computer 10 includes a central processing unit (“CPU”) 20 for executing computer-executable process steps and interfaces with a computer bus 21. Also shown in FIG. 1B are a video interface 22, a network interface 23, a display device interface 24, a keyboard interface 25, a pointing device interface 26, and storage device 15.

As described above, storage device 15 stores operating system program files, application program files, web browsers, and other files. Some of these files are stored using an installation program. For example, CPU 20 executes computer-executable process steps of an installation program so that CPU 20 can properly execute the application program.

Random access memory (“RAM”) 27 also interfaces to computer bus 21 to provide CPU 20 with access to memory storage. When executing stored computer-executable process steps from storage device 15 (or other storage media such as floppy disk 16 or WWW connection 12), CPU 20 stores and executes the process steps out of RAM 27.

Read only memory (“ROM”) 28 is provided to store invariant instruction sequences such as start-up instruction sequences or basic input/output operating system (BIOS) sequences for operation of keyboard 13.

Computer-executable process steps, according to one aspect of the present invention may be performed using the Internet. The following provides a brief description of the Internet.

The Internet connects plural computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (XML) as published by W3C Consortium, Version 1, Second Edition, October 2000, ©W3C may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network. The web browser may run on any computer connected to the Internet. Currently, various browsers are available of which two prominent browsers are Netscape Navigator and Microsoft Internet Explorer. The Web Browser receives and sends requests to a web server and acquires information from the WWW. A web server is a program that, upon receipt of a request, sends the requested data to the requesting user.

A standard naming convention known as Uniform Resource Locator (“URL”) has been adopted to represent hypermedia links and links to network services. Most files or services can be represented with a URL. URLs also enable two programs on two separate computers to communicate with each other through simple object access protocol (“SOAP”), extensible markup language (“XML”), and other protocols published by the W3C consortium, incorporated herein by reference in its entirety.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP). It is noteworthy that the invention is not limited to standard WWW or W3C protocols for server access and information exchange.

System Architecture:

Those skilled in the art will appreciate that there are adaptations and modifications of the system described herein. The foregoing description is intended to be only an example of a system that could be used in practicing the current invention.

The system comprises a host computer 10 with a monitor 11 used as an output device to view the results of a user query, a keyboard 13 as an user input device for entering data and user commands, and a pointing device 14 as an user input device to process objects displayed on monitor 11. The host computer 10 could be a stand-alone computer or a computer within a network of computers connected by Network connection 12. It is noteworthy, that the term workplace, as described in this invention, can be a factory, a warehouse or a company within the confines of which the worker is assigned one or more tasks.

FIG. 3 shows a block diagram of a system 38 that is used, according to one aspect of the present invention. System 38 may be located in a computing system similar to the one described above with respect to FIG. 1A/1B. System 38 may include a database module 39, a user interface 37 and an evaluation module 40 that are described below in more detail.

Database module 39 includes an initial database 34, a matching database 35 and an updated database 39. Initial database 34 includes a worker database 34A and a task database 34B, described in more detail below. System 38 provides a means for accessing, matching and (updating the worker attributes of a worker in worker database 34A and task attributes of a task in task database 34B via user interface 37.

Initial database 34 refers to an original worker database 34A and the task database 34B before a matching or evaluation step is performed. The worker database 34A includes attributes of one or more workers in a workplace including personal information as described below. The task database 34B includes attributes related to a plurality of tasks. The task database 34B further details one or more task configurations, each of the task configuration providing a sequence of one or more operations that a worker needs to follow to complete a task, the tools required to complete each of the operations within a task and range of postural choices to follow in order to complete each of the operations within a task.

The task configuration with worker match could be a) a combination database (matching database 35) that is created temporarily or permanently and is populated with the information from both the worker database 34A and task database 34B.

The user interface 37 permits access to the worker database 34A and task database 34B. An example of user interface 37, for use in this invention, may be a password protected screen displayed on the monitor 11 connected to the host computer 10 or one or more computers on the intranet, providing access to the databases on the intranet. User interface 37 also accepts user input for querying against the worker database 34A and task database 34B, validates the information entered by the user against the worker database 34A or task database 34B to ensure that the user entered a valid worker identification or task identification, runs a query using the user input to find a match and displays the match result.

A user may enter data/commands using keyboard 13. The mouse 14 may be used to process objects displayed on monitor 11. The output device connected to the computer within the intranet, such as monitor 11 may be used to display match result(s) or the results of a user query.

Evaluation module 40 evaluates a match of worker attributes with a task configuration(s). Evaluation module 40 accepts user input, queries the worker database 34A for a specific worker using the worker identification, validates the worker identification on the worker database 34A, matches job identification in worker database 34A with related job identification in task database 34B compares the match with a worker satisfaction rating (using matching database 35) and provides the user with match result on an output device such as a monitor 11 via user interface 37.

Once the worker satisfaction rating is met, the worker database 34A and task database 34B are updated. The evaluation module 40 also allows modifications to the worker database 34A and task database 34B when a specific satisfaction rating is met.

The updated worker database and task database 36 reflects the modified attributes of either the worker or the task or both. Modifications that can be done to the worker database are a) the job identification information for the worker, (For example: if the worker is re-assigned to a different job), b) the medical condition, (For example: if the worker's medical condition changes) or c) the physical limitations (For example: if the physical limitations change for the worker during the period of employment). The modifications that can be done to the task database are: a) one or more operations for a task, b) one or more tools used to complete each operation, c) one or more postures used to complete each operation, or d) the sequence of operations for each task.

It is noteworthy that the evaluation module 40 may be either a) a software application (or applet) implemented in various programming languages as instructions to be executed by one or more processors on one or more computers under the direction of the software applications or b) application specific integrated circuits (ASICs) implementing the functionality or c) a combination of software application and ASICs implementing the functionality of the evaluation module.

Process Flow

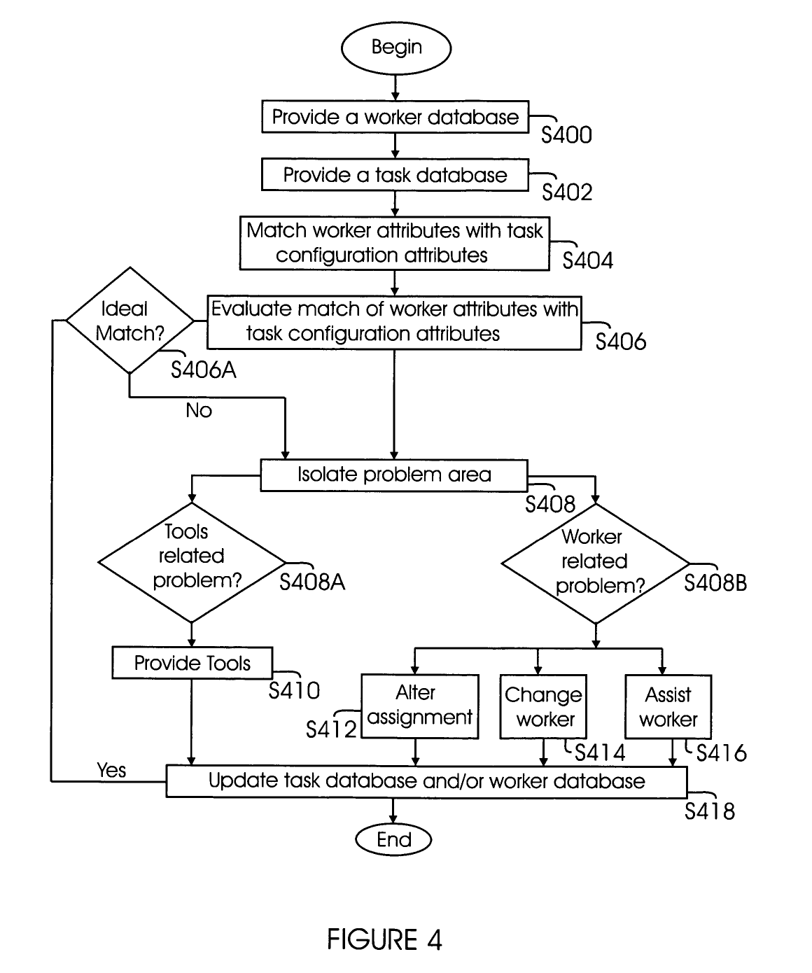

FIG. 4 shows a flow diagram of process steps used according to one aspect of the present invention. In step 400, a worker database 34A is provided on a computing system. The worker database 34A may already exist on a computing system and access is provided thereto; or the worker database 34A is created on a computing system, populated with attributes for a plurality of workers within a workplace. Access to the worker database 34A may be via user interface 37 using for example, a password protected screen. Worker database 34A may be created using one of many database creation tools, for example, SQLserver. The worker database 34A includes attributes related to the worker.

The worker attributes could include worker name, worker identification number, job identification, address, social security number or government issued identification number, home telephone number, work telephone number, mobile telephone number, date of birth, age, gender, height, weight, (right or left handedness,) education level, skill set, skill proficiency, experience, worker's medical restrictions, job interest, knowledge, physical ability (strength and flexibility,) and physical limitations.

A task database 34B is also provided in step 402. Task database 34B may reside in the same computing system as the worker database 34A or on a different computer within a network of computers accessible using the Network connection 12. Task database 34B may already exists on a computing system and access is provided in step 402; or task database 34B is created on a computing system, populated with attributes related to a comprehensive list of assignable tasks within a workplace and then access is provided. The access to task database 34B may be provided via user interface 37 using a password protected screen displayed on a display device such as a monitor 11 connected to the computer 10, for example.

Task database 34B provides a comprehensive list of tasks and one or more task configurations to perform each of the task. Each task configuration has a sequence of (including combination of sequences) operations that are performed to complete the task. For example: The task configuration for performing the task of installing a door may include the operations of: a) reaching for the appropriate door—for example: right hand side or left hand side, b) lifting the door, c) carrying the door to the door opening, d) aligning the door to the door opening, and e) attaching the door using the appropriate fixtures and tools. There can be more than one task configuration for a given task. For example: An alternate task configuration for the task of installing door may include the operations of: a) reaching for the appropriate door, b) loading the door onto a fork-lift, c) moving the door to the opening using the fork-lift, d) aligning the door to the opening, and e) attaching the door using appropriate fixtures and tools.

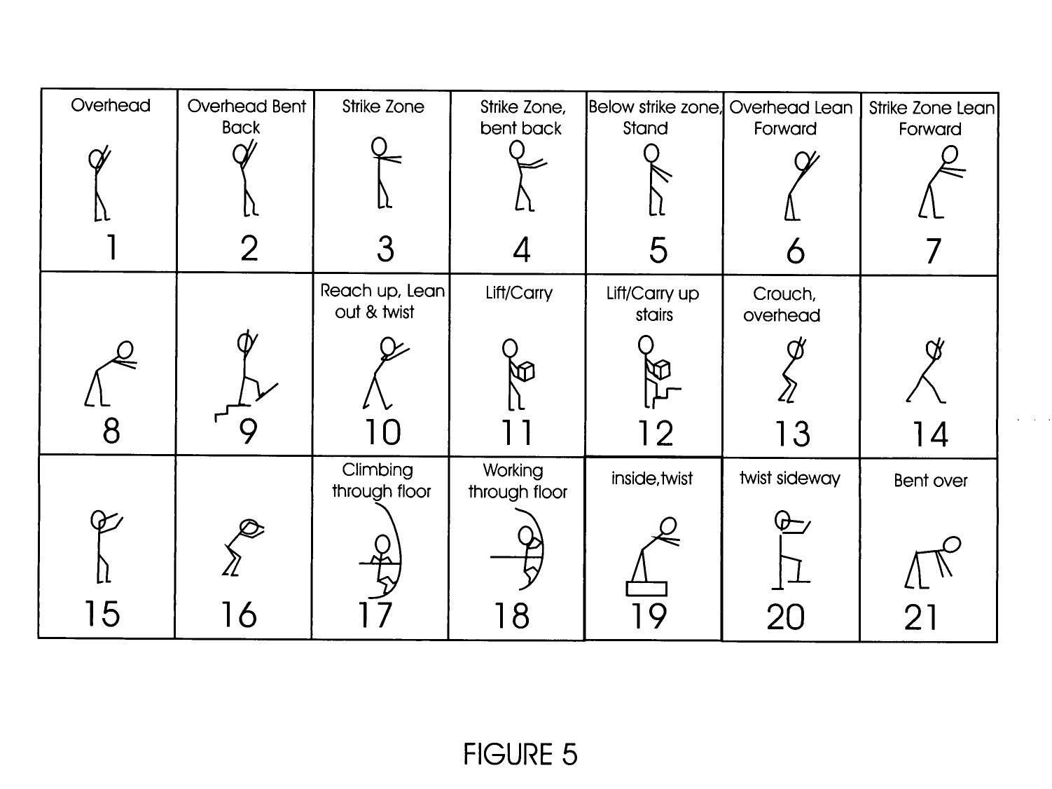

Each operation or a task, in turn, can include one or more tools required to complete the operation and one or more postures that can be engaged in performing the operation. The postures in the task database 34B could include postures that meet the recommended ergonomical safety standards, where applicable. The task database 34B includes task configuration attributes related to a plurality of tasks, one or more task configurations within each task, one or more operations within each task configuration, one or more tools used to complete each operation, and one or more postures used to complete each operation. FIG. 5 shows an example various positions and postures that may be used in performing certain tasks.

The task configuration attributes could include job identification, job description, skill set, education level, experience, physical ability, knowledge, minimal height requirement, minimal weight requirement, nature of task, duration of task, configuration identification, configuration description, operation number, operation description, time spent, number of repetitions, posture number, posture image, posture description, tool number, tool description and tool usage.

The tools required to complete each operation of a task could be broadly classified into protection tools and facilitation tools. Protection tools are tools that are used to safe-guard and protect the worker in the environment in which he/she performs the task. Some examples of protection tools are: gas masks, gloves, non-slippery shoes, goggles to protect eyes, noise-reducing or noise-cancellation ear-muffs.

Facilitation tools are those that are used to help the worker in performing the task efficiently. Some examples of facilitation tools are: power driven screwdrivers, automated stairs for climbing, power operated lifts.

It is noteworthy that the present invention is not limited to any particular classification of tools.

The postures within the task database 34B could include anyone or combination of static images and dynamic images. The static images could include photographs, pictures, clip art, digital images captured on a camera or scanned from a document and uploaded onto the task database. The dynamic images could include video clips, digital images; animated images captured using any one or a combination of video camera, digital camera, web camera and uploaded onto the task database 34B. The postures within the task database also include ergonomically safe postures (FIG. 5).

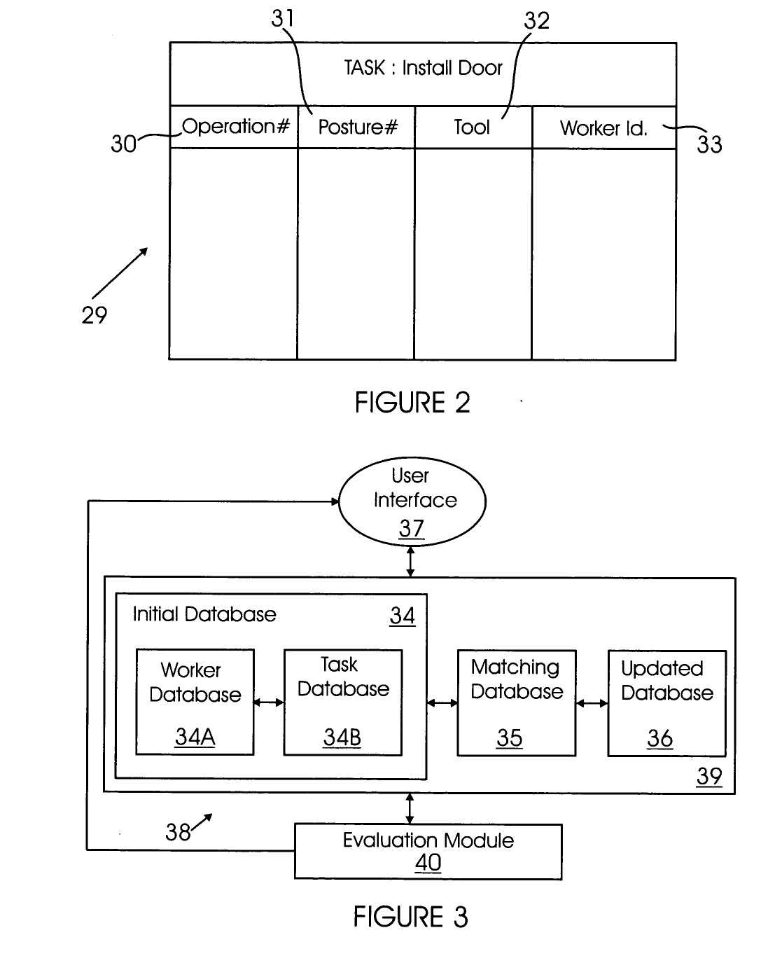

FIG. 2 shows an example of a task that could be assigned to a worker with worker Identification 33, the sequence of operations 30 (represented by an operation number or operation description) that are to be carried out to complete the task, the tools 32 and postures 31 (represented by posture number) to be engaged in completing each of the operations, as illustrated in FIG. 2 of the drawings. An example of a task 29 could be to install door in an aircraft. There could be more than one task configuration to complete the task. Based on the task configuration, the sequence of operations 30, the postures 31 and tools 32 to complete each of the operations could be different.

The task database 34B provides a plurality of task configurations that could be used to complete each task and identifies the sequence of operations 30 within each configuration, including postures 31 and tools 32 used to complete each operation. For example: The task configurations to install the door can follow a manual path configuration or a semi-automatic path configuration. The manual path configuration could be to use manual labor to fix the door and semi-automatic path could be to use a machine (tool), such as a fork-lift, to lift the door. The manual path configuration could use the following operations 30 to complete the task of installing door: a) reaching for the appropriate door—for example, right hand side or left hand side, b) lifting the door, c) carrying the door to the door opening; d) aligning the door to the door opening; e) attaching the door using the assigned fixtures and recommended tools.

Postures 31 that may be used to complete the operation of reaching for the appropriate door could include spreading the legs to balance the weight of the worker's body and the object (door, in this example), bending forward, outstretching both hands, grasping the door on opposite sides.

Tools 32 that could be used in the operation of reaching for the appropriate car door could be non-slippery shoes—if the floor is smooth and slippery, heavy-duty gloves to protect the worker(s) hands in case where the reaching is done manually.

The semi-automatic path configuration could use the fork-lift to lift the door and align it to the opening and then manually fixing the door. The semi-automatic path could use the following operations to complete the task of installing the door: a) reach for the appropriate door, b) load it onto the fork-lift, c) move the door and align it to the opening, and d) attaching the door using appropriate fixture and recommended tools.

Postures 31 for the semi-automatic path configuration could be to bend forward at the waist, and position the fork-lift under the door for allowing movement of the door. For the operation of reaching for the door using a lifting mechanism, the tools 32 that could be used are a fork-lift to lift the door, gloves for the worker operating the fork-lift and for the worker loading the door to the fork-lift.

The task database 34B recognizes the two different configurations for the same task (or multiple configurations available for same task,) and identifies the two configurations, sequence of operations 30 within each configuration, postures 31 and tools 32 used to complete each of the operation 30. In addition, the task database could provide ergonomically safe postures that could be used to complete each operation. The postures and tools to be used could be refined to meet worker satisfaction as described in greater detail hereunder.

Referring again to the process flow diagram of FIG. 4 and more specifically to step 404, after the initial provision of the worker database 34A and task database 34B, the two databases are matched for a worker, by identifying a sub-set of attributes for the worker in the worker database 34A and using the sub-set of attributes to match to the task configuration attributes in the task database 34B.

The step of identifying a sub-set of attributes for the worker is by first accepting the worker identification from the user, validating the worker identification against the worker database 34A to ensure the worker is a valid employee in the workplace and identifying a sub-set of attributes for the worker related to the task. The sub-set of attributes for a worker could be one or more of the worker attributes for the worker. For example: In one embodiment of the invention, the worker attributes that could be used to match the worker database with the task database could be Job Identification. In another embodiment of the invention, the worker attributes can include one or more of Job Identification, height, weight, age, gender, physical ability, medical condition and physical limitations.

The matching step may be performed by identifying records from the worker database 34A and task database 34B based on the attributes of the worker. The result may be formatted and displayed on the display device, such as monitor 11 of a computer 10, directly.

The matching step may als9 result in a matching database 35, which is created using database creation tools such as SQLserver. The records from the worker database 34A and task database 34B are identified using the sub-set of attributes of the worker. The matching could be done using a standard database query tool.

Using the same example of a worker assigned to install the door, the following description will explain the matching process. A user enters the name of the worker and the worker identification onto the query screen acting as a user interface 37, for example, using the keyboard 13. The query screen is displayed on the monitor 11 connected to the computer. The database query tool, using the sub-set of the attributes of the worker provided by the user, queries the worker database 34A and the task database 34B to identify the records that match the query.

The identified records, in one embodiment of the invention, are formatted and displayed on the monitor 11. In another embodiment of the invention, the combination database 35 is populated with the attributes from the identified records and then the records from the combination database are formatted and displayed on the monitor 11. In this case, the worker database 34A will provide the job identification number and the task database 34B would provide the details of the sequence of operations for the task of installing the door, the tools recommended to perform each operation and postures recommended to complete each operation of the task of installing the door.

After the matching process, in step 406, the matching results are evaluated. The step of evaluating the match is performed using evaluation module 40. During evaluation, the results of the match are validated against worker satisfaction rating. The worker satisfaction rating may be a range of numbers—zero to ten, for example, with zero showing least satisfaction and ten showing most satisfaction.

When the worker satisfaction rating is high, the match may be categorized as an “ideal match”, as determined in step 406A. When an ideal match is met (for example: worker satisfaction rating of 6 or more), the process flows down to the next step of updating the worker database 34A and task database 34B, as indicated in step. The updated database 36 is shown in FIG. 3. The term ideal match is not to be construed as limiting, in the adaptive aspects of the present invention.

If the ideal match is not found in step 406, then in step 408, the problem is isolated and resolved. The problem could be broadly classified as tools based (408A) and/or worker based (408B). The tools based problem may occur when one or more operations that the worker is assigned to perform could potentially harm the worker. Worker based problem could be broadly grouped under worker exertion. By evaluating the environmental conditions of the task and worker attributes, the problem can be isolated.

If the problem area is lack of tools, the solution could be to provide the appropriate protection or facilitation tools to facilitate the worker to complete the task safely (as illustrated in step 410 of FIG. 4).

If the worker, is unable to complete a given task because of physical exertion due to physical limitations or medical condition developed, the solution may be provided by: altering assignment of the worker (as illustrated in step 412 of FIG. 4); changing the worker (as illustrated in step 414 of FIG. 4), or 3) assisting the worker (as illustrated in step 416 of FIG. 4).

Altering assignment of the worker could be accomplished by first identifying the worker attributes of the worker such as physical limitations of the worker, the task that the worker is currently assigned, operations within the task, the posture(s) and tool(s) to complete each operation. Then, either the posture(s) or tool(s) or both or the operations to complete the task are modified to work around the physical limitation of the worker. Then, the worker satisfaction is evaluated using the evaluation software against the modified operations, posture(s) and/or tool(s). Upon finding an ideal match, the process flows to the next step of updating the task database 34B to reflect the change (step 418 of FIG. 4).

The following description provides an example of altering assignment of the worker. The task that a worker is assigned to could be installing a door. The physical limitation that the worker has developed could prevent him from lifting the door because of a bad back. The task could be modified wherein the worker can do all the other operations to install the door except lifting the door and aligning it to an opening. Altering the assignment of the task or the operations within the task to meet the physical limitations of the worker helps the worker in achieving optimal productivity. In this example, the task database 34B would be updated with attributes that would reflect the modified sequence of operations within the task that the worker is assigned.

Changing the worker (in step 414) could be accomplished by re-assigning the task to a new worker. This can be accomplished by performing the steps of: a) first identifying worker attributes of the worker currently assigned to a task (current worker), b) identifying the worker attributes of a new worker who meets the task configuration attributes for the task and c) modifying one or more attributes of the current worker and new worker in the worker database 34A based on the re-assignment of the task. The step of identifying a new worker can be performed by: a) providing access to the worker database and task database, b) identifying task configuration attributes from said task database 34B for said task, c) identifying worker attributes of one or more alternate workers that meet the task limitations and requirements for the task, and d) choosing a worker from the group of alternate workers that meet the task limitations and requirements, as the new worker.

When a worker is unable to accomplish the assigned task due to physical limitations, the worker is assisted to find a new task, in step 416. The step of assisting the worker in finding a new task can be accomplished by performing the steps of: a) identifying the worker attributes of the worker in the worker database 34A, b) identifying the task currently assigned to the worker, c) identifying the physical limitations of the worker, d) identifying task configuration attributes for a new task based on the physical limitations of the worker, and e) modifying the worker database 34B to update the attributes related to the new task upon successful re-assignment of the new task to the worker.

Referring back to the worker assigned the job of installing the door in the earlier mentioned example, if the worker assigned to install the door develops physical limitations such as bad back or other medical conditions that prevents the worker from lifting weights, the worker database 34A is first queried, using database query tools, to identify the worker record and attributes of the worker related to a task. Examples of the attributes related to a task could include skill set, interest, education, experience, and physical ability. Using the attributes of the worker from the worker database 34A and the physical limitations that prevent the worker from performing the assigned task of installing the door, the task database 34B is queried to identify one or more alternate tasks that the worker could perform. The worker attributes in the worker record are modified to reflect the re-assignment of the new task, after choosing one of the alternate tasks for the worker. The task might require re-training of the worker, in which case the worker is assigned the task after re-training. The worker database 34A and the task database 34b are updated with modified attributes of the worker and task assigned to the worker. This update is done after evaluating the worker satisfaction and found to be satisfactory.

The step of updating the worker database includes: a) identifying one or more records of the worker in the worker database 34A, and b) modifying one or more attributes of the worker to reflect change. For example: A worker develops physical limitations or medical condition that could prevent the worker from performing the task assigned to the worker. The worker database 34A is queried for the worker, the record of the worker identified and the physical limitations, medical condition, new task assigned attributes of the worker modified to reflect the change.

The step of updating the task database 34B (included in step 418) includes a) identifying one or more task configuration attributes of the task in the task database including sequence of operations within the task, postures and tools used to complete each operation, and b) modifying one or more attributes of the task, sequence of operation, tools or postures to reflect change.

In the task of installing the doors, the original sequence of operation to complete the task could have been a manual process and include a) reaching for the appropriate door—for example, right hand side or left hand side, b) lifting the door, c) carrying the door to the door opening d) aligning the door to the door opening, e) attaching the door using the assigned fixtures and recommended tools.

The new updated sequence of operation for installing the door could be a) reaching for the appropriate door, b) loading the door onto a fork-lift, c) moving the door and aligning the door to the door opening, and d) attaching the door using assigned fixtures and recommended tools.

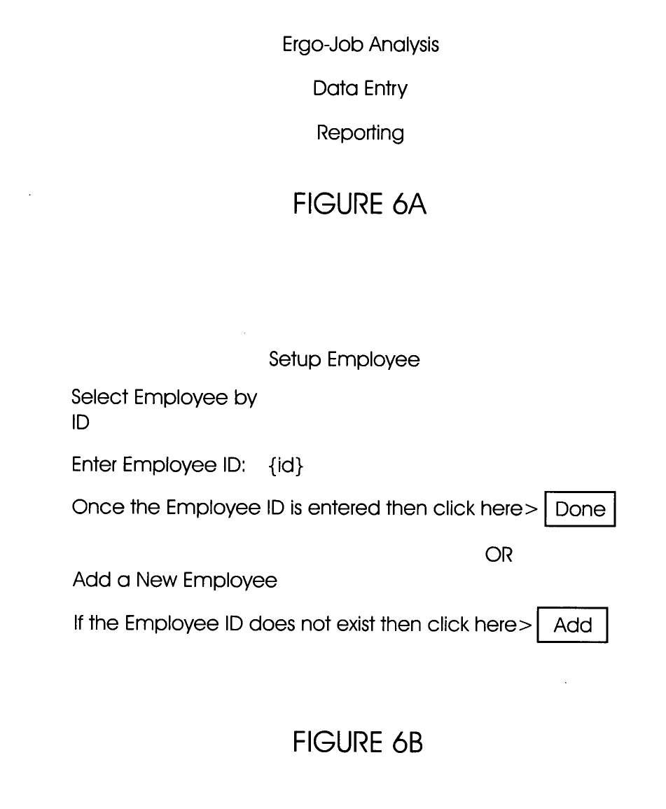

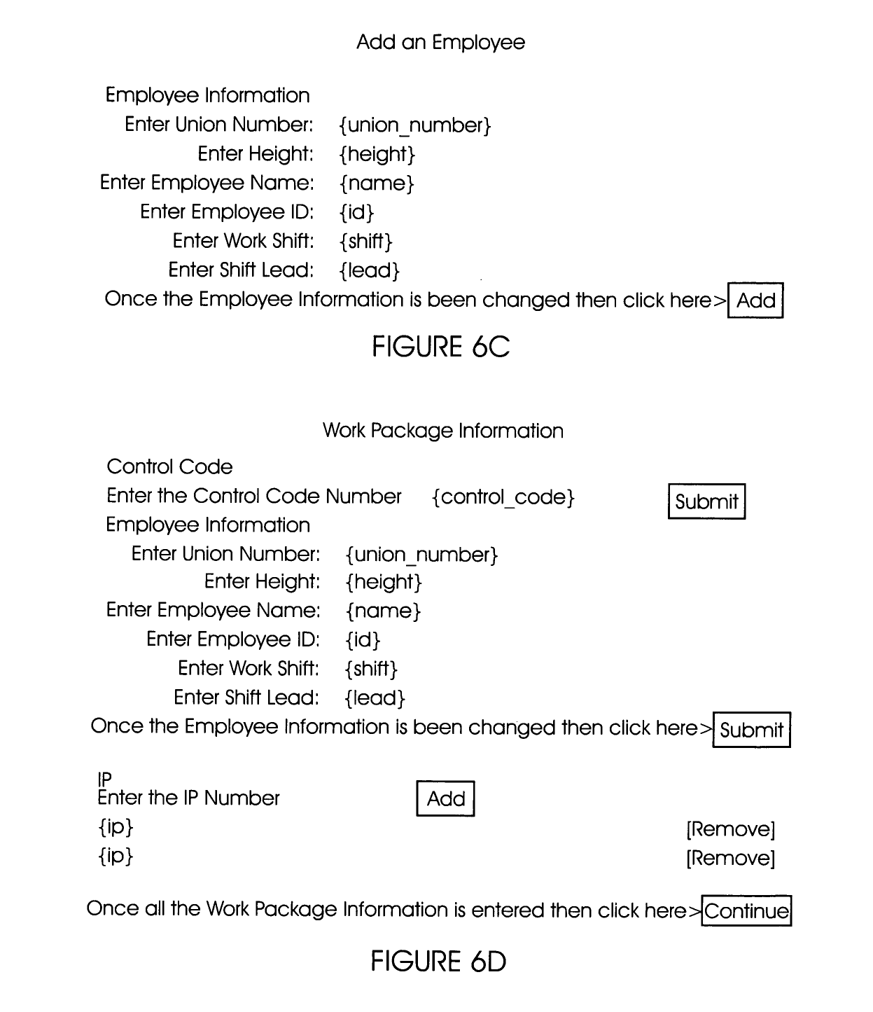

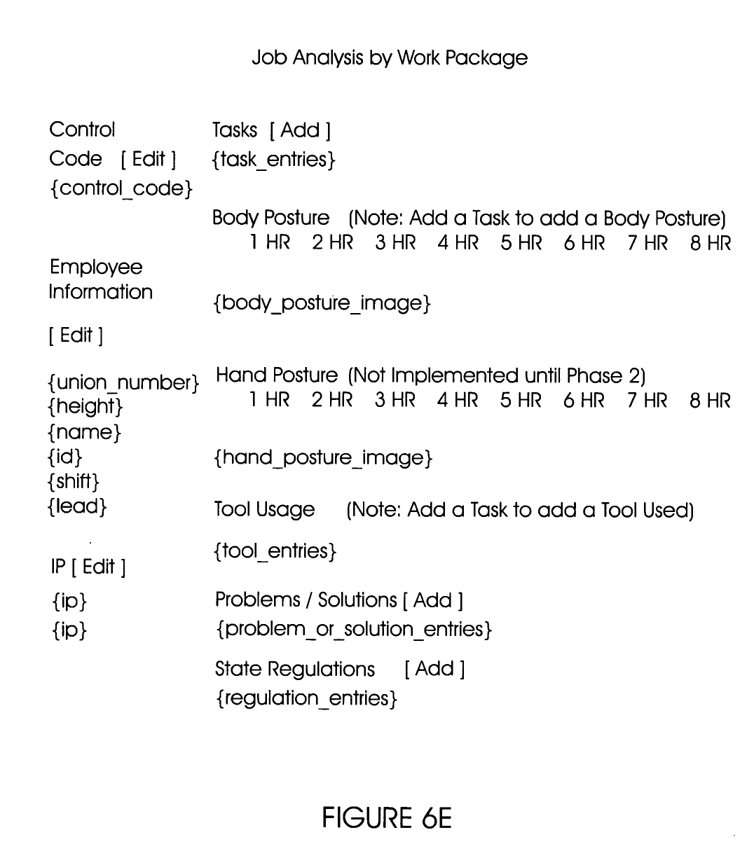

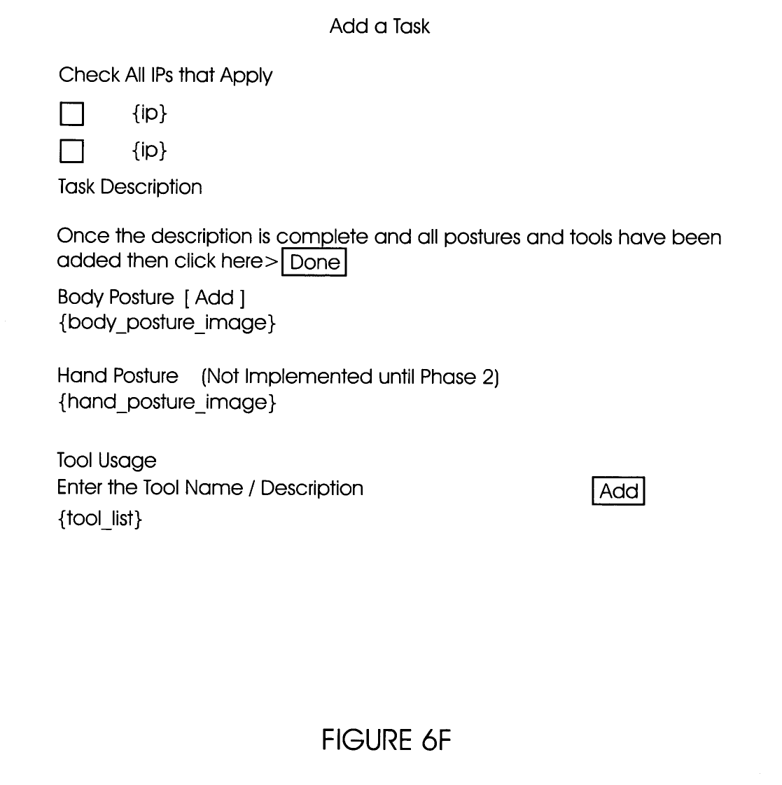

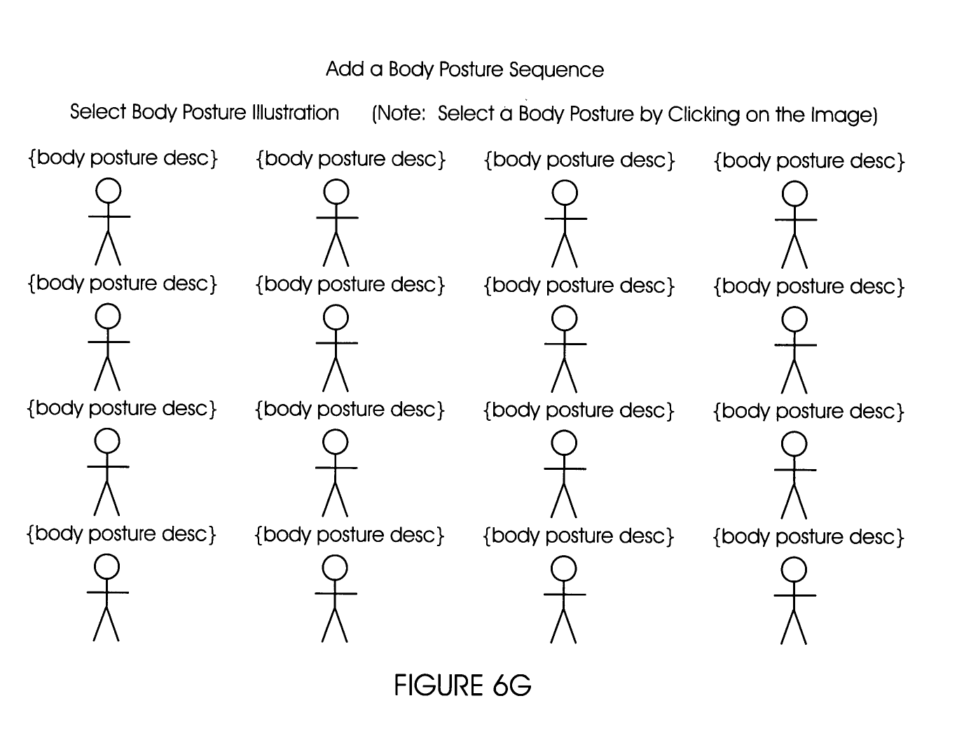

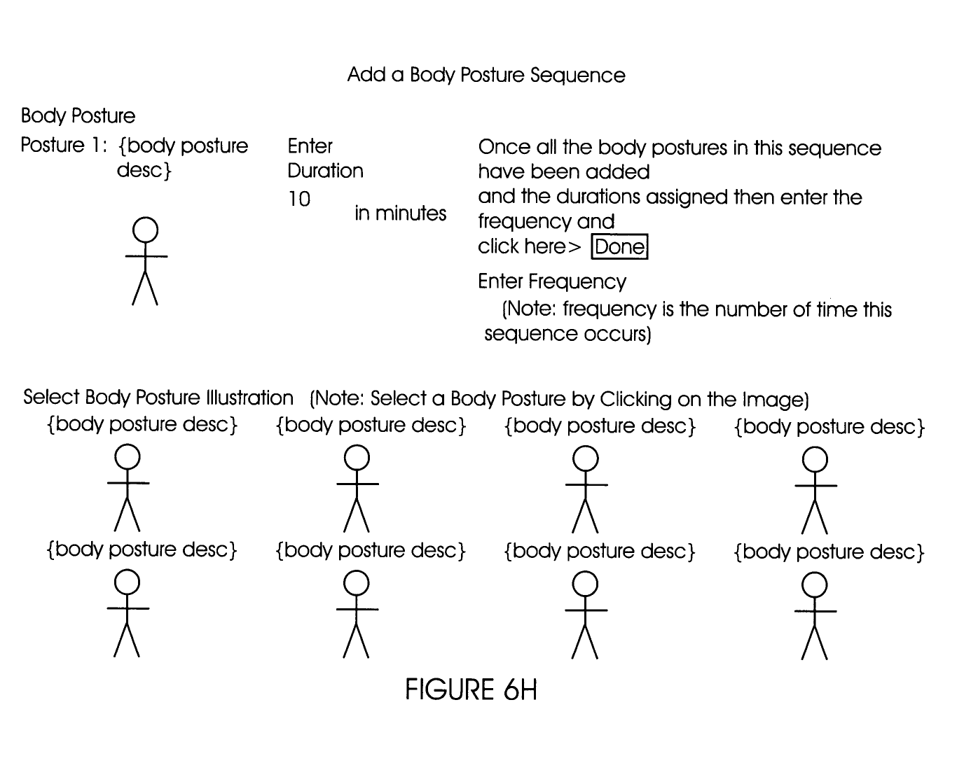

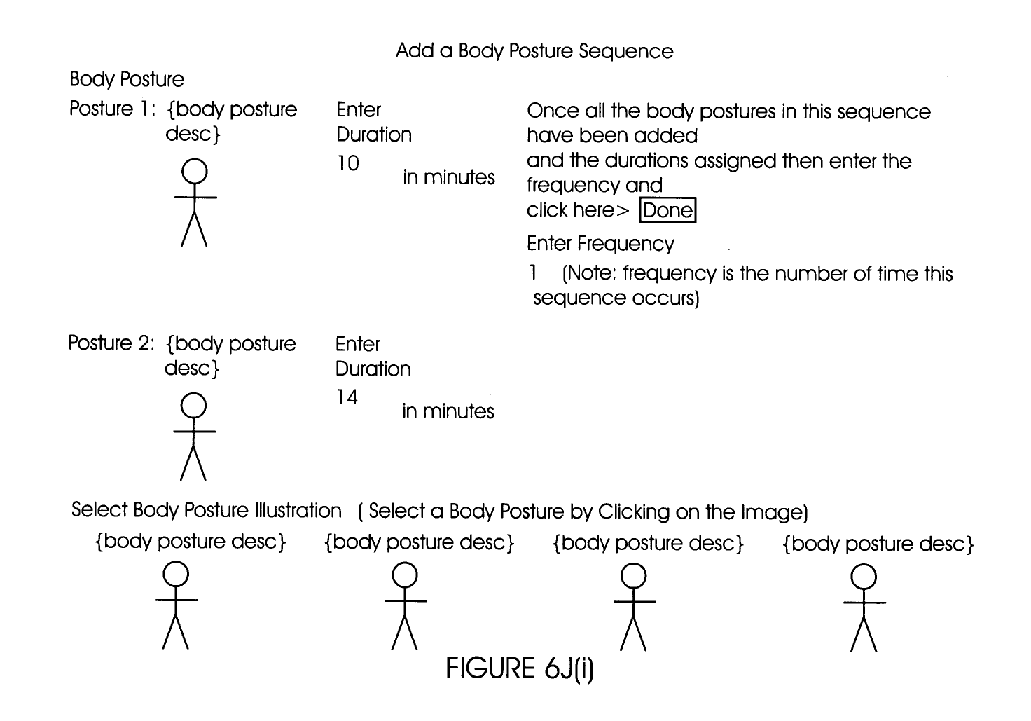

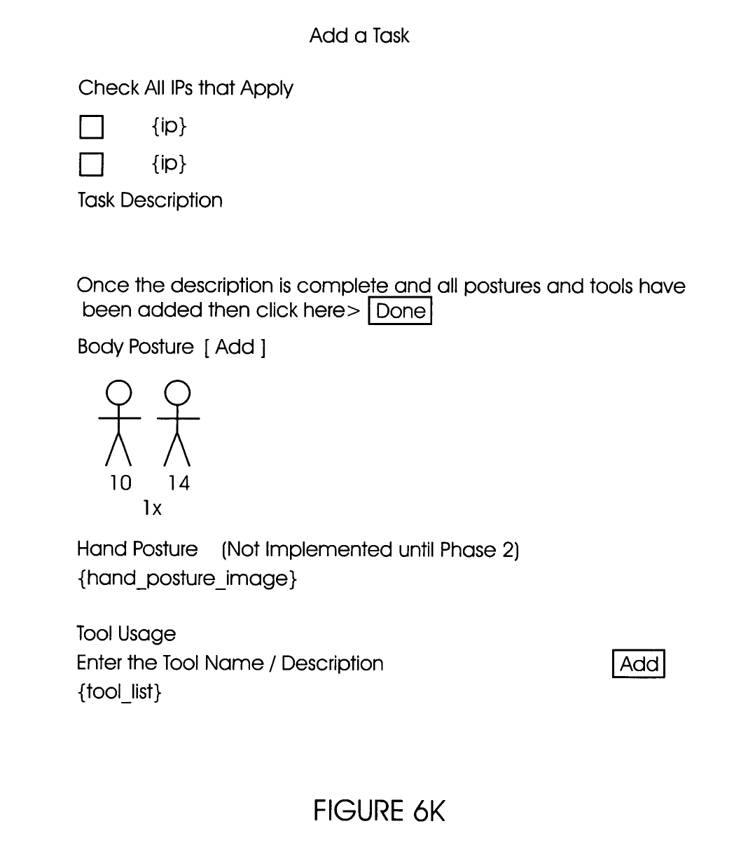

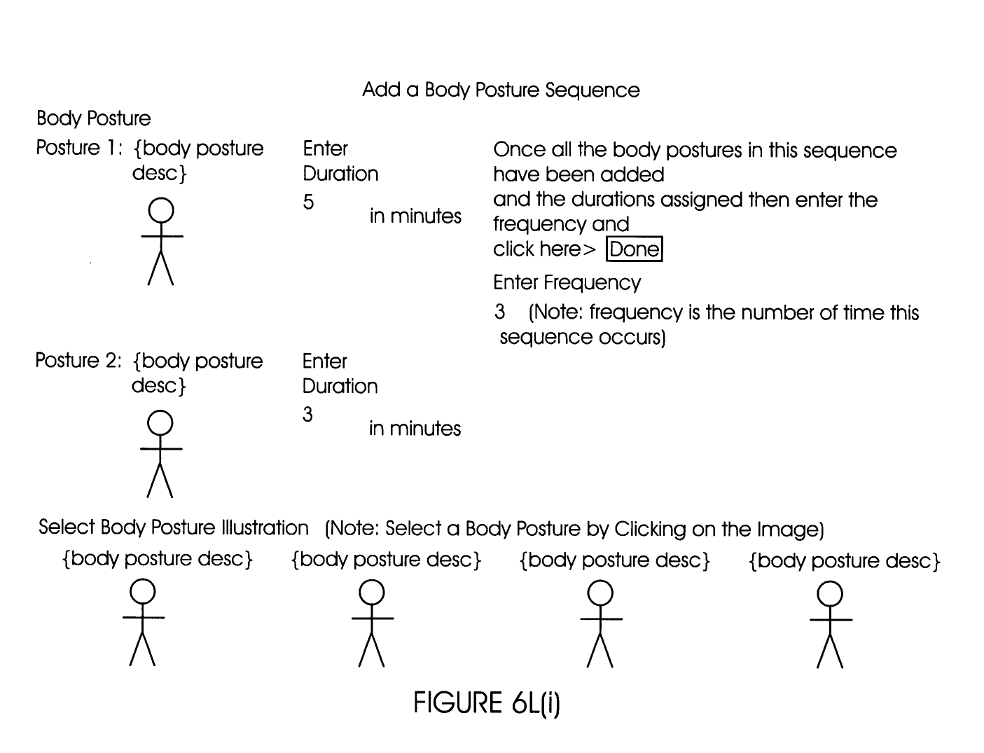

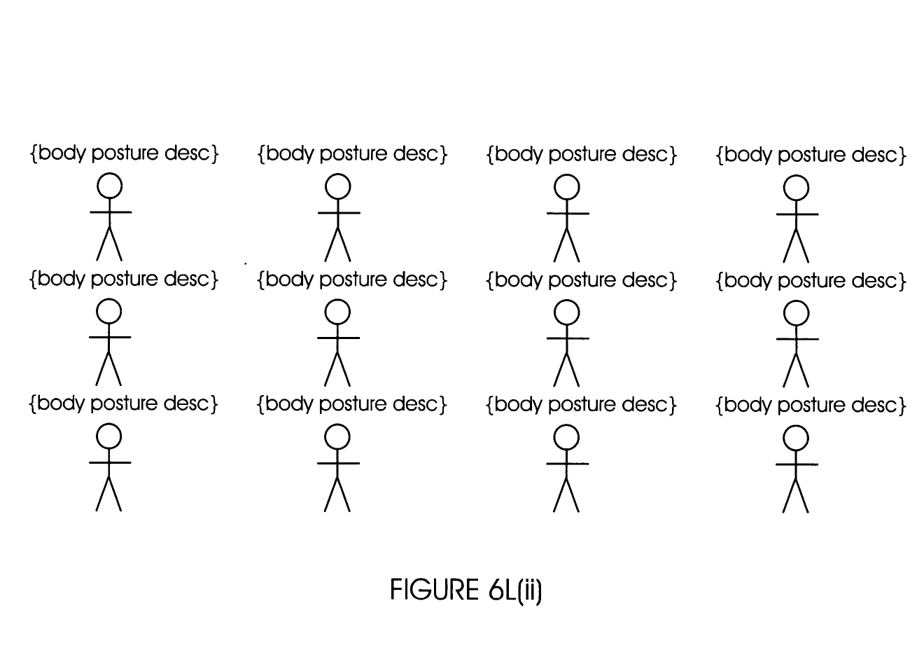

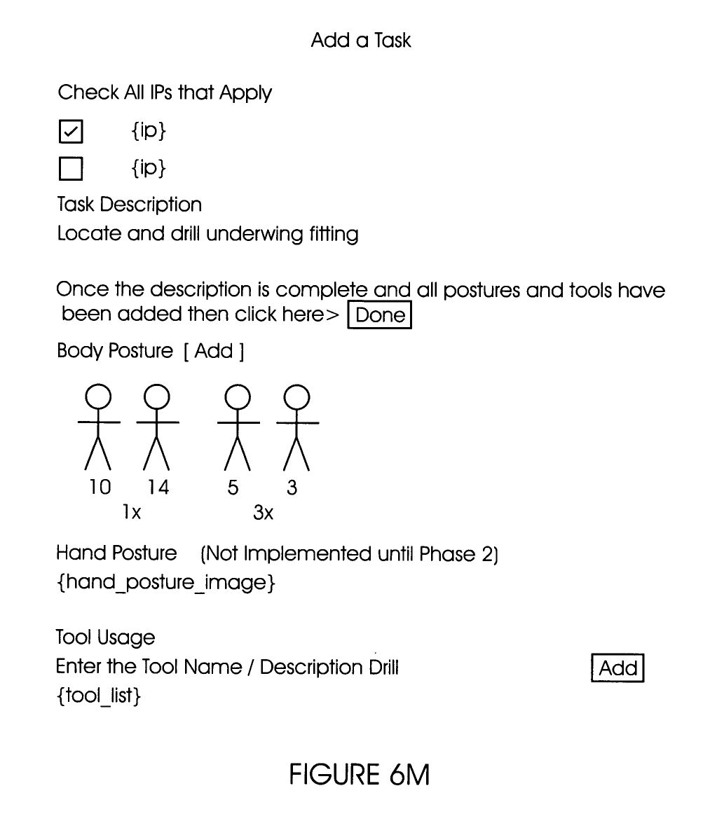

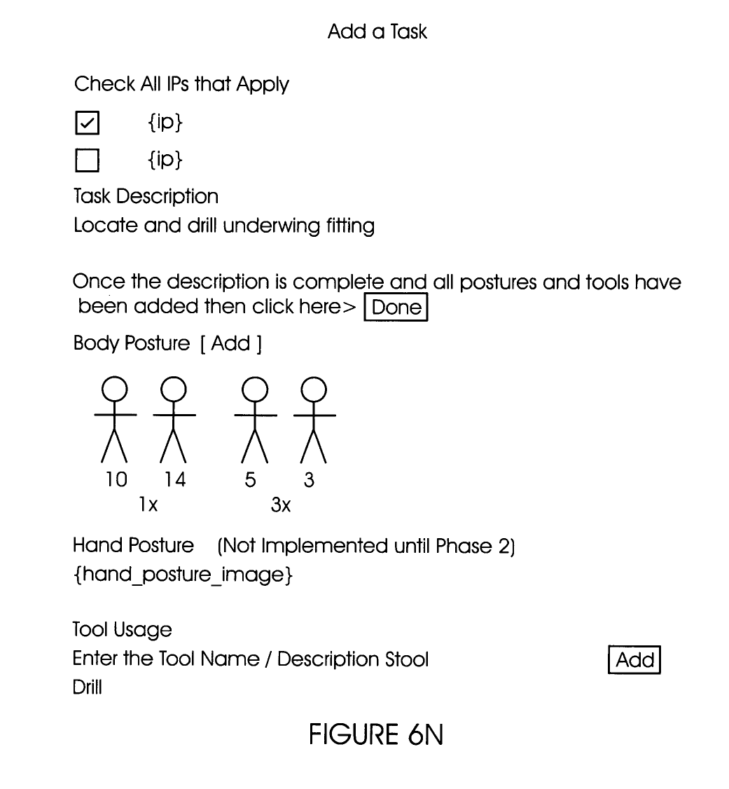

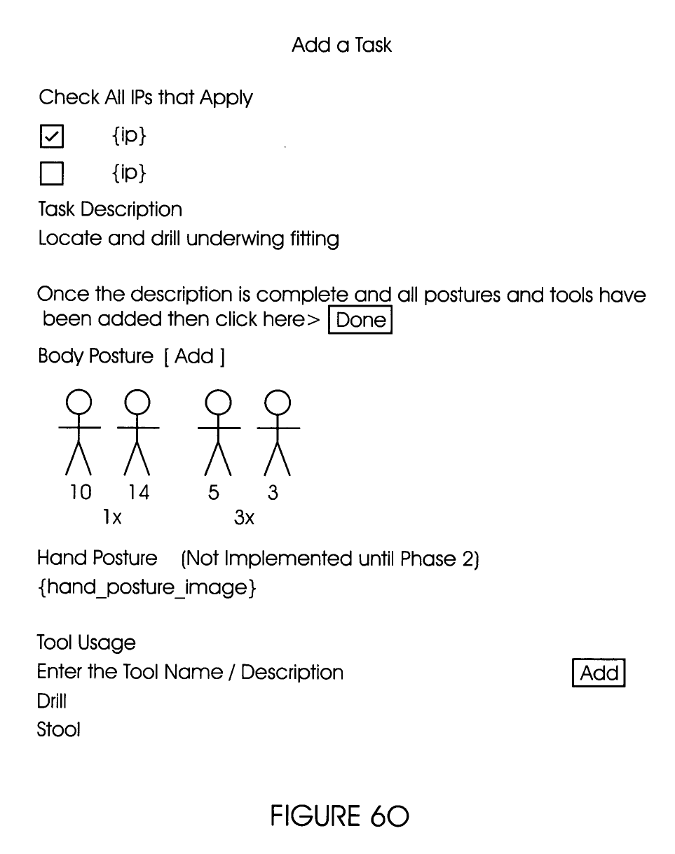

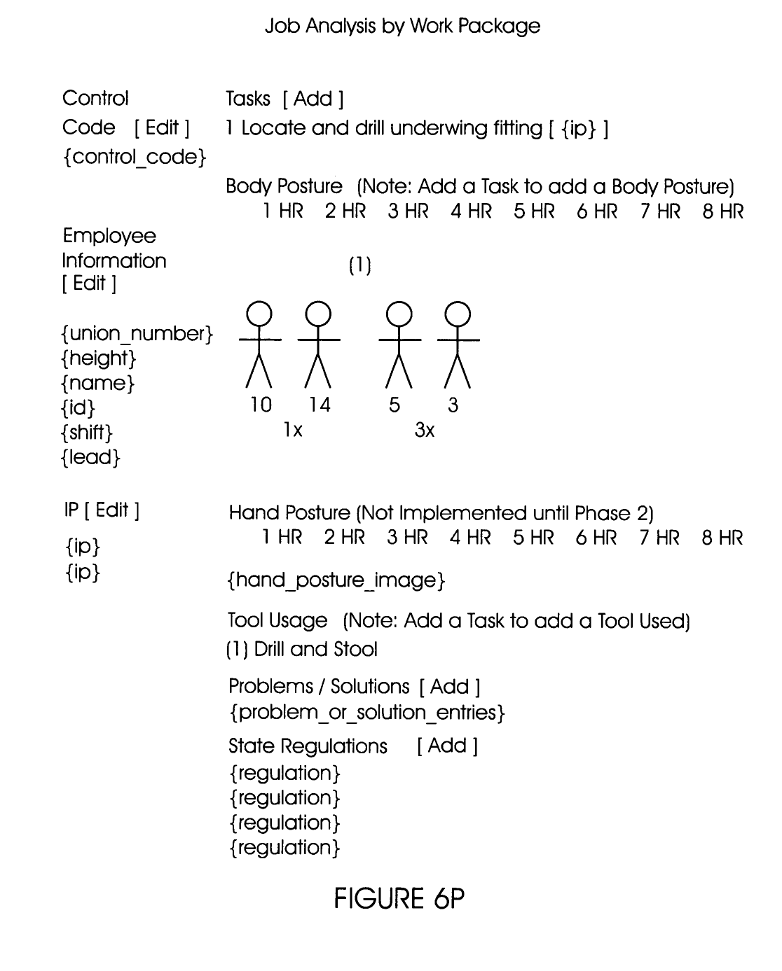

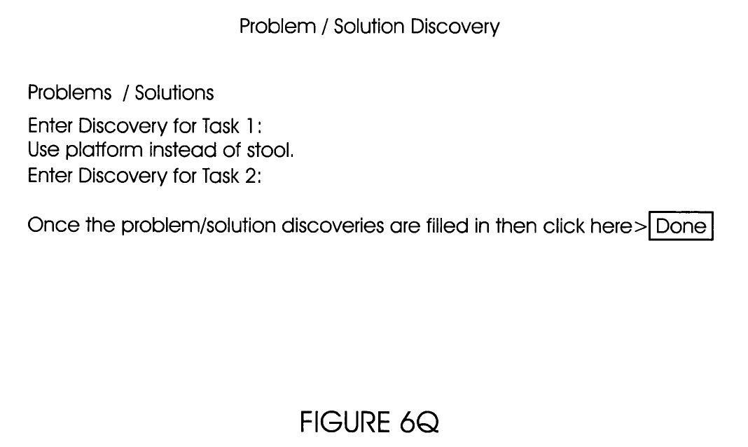

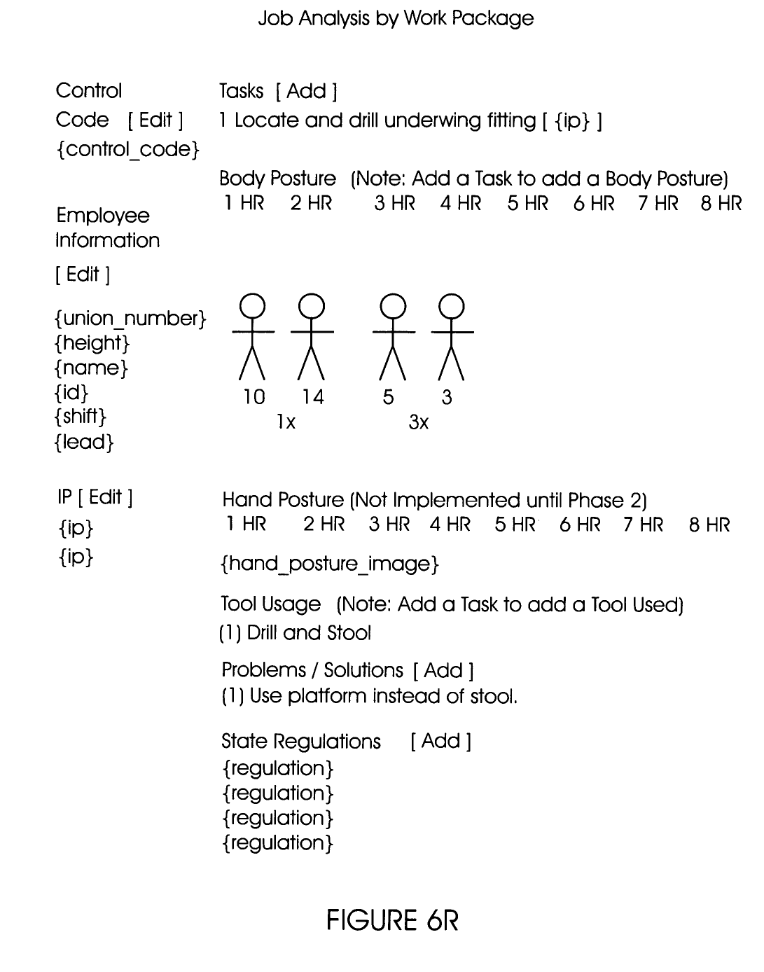

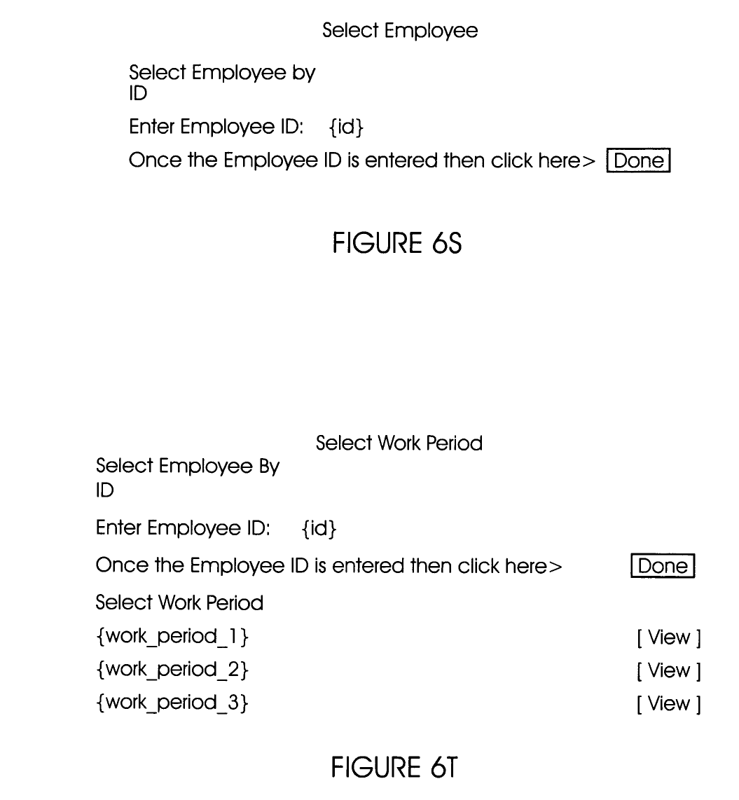

FIGS. 6A-6T show screen shots of a computerized system, according to one aspect of the present invention.

FIG. 6A shows the initial screen using user interface 37. FIG. 6B shows a screen shot for setting up worker information in worker database 34A.

FIG. 6C shows a screen shot for adding a new employee (or worker, used interchangeably throughout this specification). The workers name, height, identification (“ID”) number, shift and union number (if applicable) are added.

FIG. 6D shows how a work package (or task information) is built for task database 34B. A control code is entered that includes has information on all the installation steps (may be referred to as installation process (IP) numbers). Worker information is also added using the screen in FIG. 6D. An IP number for certain tasks may also be added. After all the task information is entered, the screen in FIG. 6E is used adding tasks, body postures, IP numbers, any state regulations that may be needed and also evaluation results, as described in detail with respect to other screen shots.

FIG. 6F shows a screen shot for adding a task. The screen allows a user to checks all the applicable IP numbers. A body posture is selected using the screen shown in Figure G. Details for the selected body posture are entered using the screen shots shown in FIGS. 6H(i) and 6H(ii). The details included the frequency for a particular body posture, i.e. the number of times a sequence occurs. FIG. 6J(i) and FIG. 6J(ii) show two body postures and the associated frequencies.

FIG. 6K shows a screen shot for adding a task. This typically occurs after a body posture(s) have been selected. More body postures may be added from the screen in FIG. 6K. FIG. 6L(i) and FIG. 6L(ii) show the two more body postures that are selected. FIG. 6 M now shows all the body postures that have been selected for a task, for example, “locate and drill underwing fitting”. The IP number box is also checked. A tool name (or number, not shown) may also be added from this screen.

FIG. 6N shows how another tool (“stool”) is added to the task. In FIG. 60 all the tools, body postures have been added. The user clicks on the “Done” icon and then moves to the screen in FIG. 6P.

The screen in FIG. 6P describes the task with a control code and includes all the body postures. Employee information is correlated to the task. The task is evaluated and if any problems are found, then the problem is added using the “Add” icon next to the Problem/Solutions icon.

FIG. 6Q shows an example of a problem entry, i.e. “use platform instead of stool”. Once all the problem/solution entries are inserted, the “Done” icon is clicked and the screen shown in FIG. 6R appears on user interface 37. This screen shows all the task information, including problem/solutions.

If another employee needs to be added or changed, then the user clicks on the “Edit” icon (or button, used interchangeably throughout this application). FIG. 6S allows a user to enter another employee's identification number. FIG. 6T screen shot allows the user to enter a work period for the worker.

While the present invention was described with respect to a particular embodiment, other embodiments, uses and advantages of the present invention will be apparent to those skilled in the art. The specifications and examples should be considered exemplary only. The intended scope of the invention is only limited by the claims appended hereto.

What is claimed is:

1. A method for analyzing work in a workplace comprising of:
providing a worker database, wherein the worker database includes a plurality of worker attributes;
providing a task database for a plurality of tasks, wherein the task database includes one or more task configurations for a task and configuration attributes for the task configurations;
matching the worker attributes with the task configuration attributes;
evaluating the match of the worker attributes with the task configuration attributes; and
updating the worker database and the task database upon satisfactory matching of worker attributes with the task configuration attributes.

2. The method of claim 1, wherein the task configurations identify a sequence of one or more operations to complete the task.

3. The method of claim 2, wherein the sequence of operation identifies one or more postures used to complete an operation.

4. The method of claim 2, wherein the sequence of operation identifies one or more tools used to complete the operations for a task.

5. The method of claim 4, wherein the tools are protection tools for providing physical protection to the worker.

6. The method of claim 4, wherein the tools are facilitation tools for assisting the worker in completing the operations.

7. The method of claim 3, wherein the postures are ergonomically safe postures.

8. The method of claim 1, wherein the worker attributes include one or more of worker name, worker identification number, job identification, address, social security number or government issued identification number, home telephone number, work telephone number, mobile telephone number, date of birth, age, gender, height, weight, education level, skill set, skill proficiency, experience, medical condition, job interest, knowledge, physical limitations, and physical ability.

9. The method of claim 1, wherein the task configuration attributes include one or more of job identification, job description, skill set, education level, experience, physical ability, knowledge, minimal height requirement, minimal weight requirement, nature of task, duration of task, configuration identification, configuration description, operation number, operation description, time spent, number of repetitions, posture number, posture description, posture image, tool number, tool description and tool usage.

10. The method of claim 1, wherein the step of matching the worker attributes with the task configuration attributes include identifying a sub-set of the worker attributes for performing the task; and b) matching the sub-set of the worker attributes with the task configuration attributes.

11. The method of claim 10, wherein the step of matching the sub-set of the worker attributes with the task configuration attributes includes a) creating a combination database, b) identifying information from the worker database and the task database for the task configuration, and c) populating the combination database with the identified information from the worker database and task database for the task.

12. The method of claim 1, wherein the step of evaluating worker attributes match with the task configuration attributes include the steps of: a) validating worker match with the task configuration; and b) isolating and resolving one or more problems with an invalid match.

13. The method of claim 12, further comprising:
identifying the problem; and b) providing a solution to resolve the problem.

14. The method of claim 13, wherein the problem is tools based.

15. The method of claim 13, wherein the problem is worker based.

16. The method of claim 13, wherein the solution includes, altering the task assigned to the worker; changing the worker assigned to the task; and assisting the worker in finding a new task.

17. A system for analyzing work in a workplace comprising:
a worker database, wherein the worker database includes one or more worker attributes;
a task database for a plurality of tasks, wherein the task database includes one or more task configurations for the tasks with attributes for one or more task configurations;
a user interface for accessing the worker database and the task database for entering worker and task information; and
an evaluation module that evaluates a match of worker attributes with the task configuration.

18. The system of claim 17, wherein the worker database is updated after the evaluation module evaluates a match of worker attributes and task configuration.

19. The system of claim 17, wherein the task configuration identify a sequence of one or more operations to complete the task.

20. The system of claim 17, wherein the evaluation module validates worker match with the task configuration; and isolates one or more problem with an invalid match.
